(19) United States
(12) Patent Application Publication
(10) Pub. No.: US 2003/0117512 A1
(43) Pub. Date: Jun. 26, 2003

(54) Digital camera

(75) Inventors: Junya Kaku, Hyogo (JP); Masahiro Shioji, Osaka (JP)

Correspondence Address: ARMSTRONG,WESTERMAN & HATTORI, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/322,610

(22) Filed: Dec. 19, 2002

(30) Foreign Application Priority Data
Dec. 21, 2001 (JP) 2001-389896

(51) Int. Cl. H04N 5/222

(52) U.S. Cl. 348/333.11

(57) ABSTRACT

A digital camera includes a signal processing circuit. The signal processing circuit sequentially outputs a plurality of frames of still image data that correspond to an object image. When a shutter button is operated in an animation mode, one frame of the still image data is recorded into a magnetooptical disk in a compressed state. When a display mode 2 is selected in the animation mode, recorded latest still image data and the still image data output from the signal processing circuit are alternately selected so as to display on a monitor a moving image on the basis of the selected still image data.

### BACKGROUND OF THE INVENTION

1. Field of the Invention

The present invention relates to a digital camera. More specifically, the present invention relates to a digital camera that supplies a plurality of screens of still image signals sequentially outputted from a photographing means, and records one screen of the still image signals into a recording medium when a photographing instruction is applied.

2. Description of the Prior Art

One example of a conventional such a kind of digital camera is disclosed in Japanese Patent Laying-open No. 2001-298693 laid-open on Oct. 26, 2001. In the prior art, an animation photographing mode is prepared, and it becomes possible to produce a so-called clay animation by the photographing mode. More specifically, respective frames are photographed by gradually changing an object such as a clay modeling doll or the like, thereby obtaining a moving image file including the respective frames of still images to be photographed.

However, if a change amount of the object is large, a movement of the object at a time of reproducing becomes awkward, and if the change amount of the object is small, a movement of the object at a time of reproducing becomes slow. Thus, it is needed to perform a photographing while confirming the change amount of the object when the clay animation is produced, thus straining a producer. Notwithstanding, in the prior art, no efforts were introduced as to easily confirm the change amount of the object.

### SUMMARY OF THE INVENTION

Therefore, it is a primary object of the present invention to provide a digital camera capable of easily confirming the change amount of the object in the animation photographing.

A digital camera according to the present invention comprises: a photographer for sequentially outputting a plurality of screens of still image signals that correspond to an object image, a recorder for recording one screen of the still image signal at every time that a recording instruction is issued; and a displayer for displaying a moving image formed of one screen of the still image signal that corresponds to a latest recording instruction and the still image signals outputted from the photographer when a specific display instruction is issued.

The photographer sequentially outputs a plurality of screens of the still image signals that correspond to an object image. The recorder records one screen of the still image signal at every time that a recording instruction is issued. The displayer displays a moving image formed of one screen of the still image signal that corresponds to a latest recording instruction and the still image signals outputted from the photographer when a specific display instruction is issued.

The still image corresponding to the latest recording instruction is included in the still image forming the moving image. Therefore, using afterimage effect, it is possible to confirm the change amount of the object between a latest recording screen and a screen about to be recorded.

Preferably, the recording instruction or the specific display instruction is generated by a key operation of a remote control device, which is separately provided from a camera main body. Therefore, a position of the camera main body is not to be changed by the key operation.

Preferably, one screen of the still image signals corresponding to the latest recording instruction is stored in a first memory, and the still image signals sequentially outputted from the photographer are stored into a second memory. Furthermore, a reading destination of the still image signals forming the moving image is alternately changed by a changer between the first memory and the second memory.

Still preferably, a change operation of the changer is suspended by the suspender in response to a change suspending instruction after the specific display instruction. This allows the still images corresponding to the latest recording instruction to be displayed in a case that the first memory is continuously selected as the reading destination. On the other hand, in a case that the second memory is continuously selected as the reading destination, the moving image formed of a plurality of screens of the still image signals outputted from the photographer is displayed. This makes it possible to elaboratively confirm the still image or the moving image.

In a case that an input key for inputting the change suspending instruction is further provided, the suspender may determine a suspending time period of the change operation in accordance with an operating manner of the input key. This increases functionability.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing constitution of one embodiment of the present invention;

FIG. 2 is a block diagram showing one example of constitution of a bank control circuit;

FIG. 3 (A) is a waveform chart showing a change timing signal;

FIG. 3 (B) is a waveform chart showing an output of a logical circuit 32f;

FIG. 3 (C) is a waveform chart showing an output of a logical circuit 32g;

FIG. 4 (A) is a waveform chart showing a change timing signal;

FIG. 4 (B) is a waveform chart showing an output of a logical circuit 32i;

FIG. 4 (C) is a waveform chart showing an output of a logical circuit 32j;

FIG. 5 is a waveform chart showing a writing-use bank control signal and a reading-use bank control signal outputted from the bank control circuit in a display mode 0 or 1;

FIG. 6 is a waveform chart showing a writing-use bank control signal and a reading-use bank control signal outputted from the bank control circuit in a display mode 2;

FIG. 7 is a waveform chart showing a writing-use bank control signal and a reading-use bank control signal outputted from the bank control circuit in a display mode 2-A;

FIG. 8 is a waveform chart showing a writing-use bank control signal and a reading-use bank control signal outputted from the bank control circuit in a display mode 2-B;

FIG. 9 is a flowchart showing one portion of a process operation of a CPU in an animation mode;

FIG. 10 is a flowchart showing another portion of the process operation of the CPU in the animation mode;

FIG. 11 is a flowchart showing the other portion of the process operation of the CPU in the animation mode;

FIG. 12 is a flowchart showing further portion of the process operation of the CPU in the animation mode;

FIG. 13 is an illustrative view showing an accessing manner to banks A and B in the display modes 0 or 1;

FIG. 14 (A) is an illustrative view showing one example of a monitor display in the display mode 0;

FIG. 14 (B) is an illustrative view showing one example of the monitor display in the display mode 1;

FIG. 15 is an illustrative view showing an accessing manner to the banks A and B in the display modes 2;

FIG. 16 is an illustrative view showing one example of a monitor display in the display mode 2;

FIG. 17 is an illustrative view showing an accessing manner to the banks A and B in the display modes 2-A;

FIG. 18 is an illustrative view showing one example of a monitor display in the display mode 2-A;

FIG. 19 is an illustrative view showing an accessing manner to the banks A and B in the display modes 2-B;

FIG. 20 is an illustrative view showing one example of a monitor display in the display mode 2-B;

FIG. 21 is a block diagram showing constitution of another embodiment of the present invention;

FIG. 22 is a waveform chart showing a writing-use bank control signal and a reading-use bank control signal outputted from the bank control circuit in the display mode 2-A;

FIG. 23 is an illustrative view showing an accessing manner to the banks A and B in the display modes 2-A; and

FIG. 24 is a flowchart showing one portion of the process operation of the CPU in the animation mode.

### DETAILED DESCRIPTION OF THE PREFERRED EMBODIMENTS

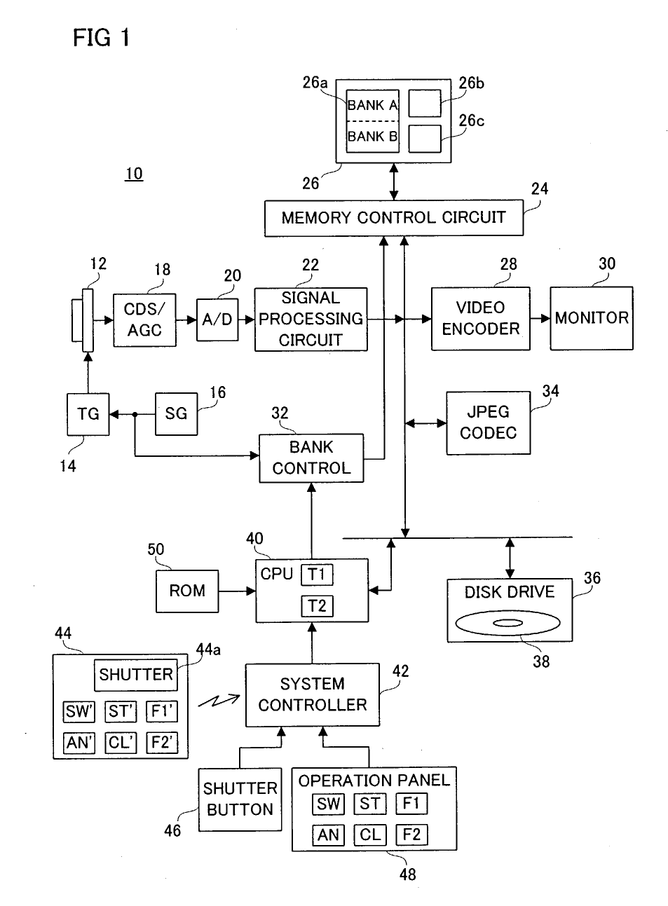

Referring to FIG. 1, a digital camera 10 in this embodiment includes an image sensor 12. An optical image of an object is incident on a light-receiving surface of the image sensor 12, and a camera signal (raw image signal) that corresponds to the incident optical image is produced by a photoelectronic conversion. A timing generator (TG) 14 reads out the camera signal from the image sensor 12 in response to a vertical synchronization signal and a horizontal synchronization signal outputted from a signal generator (SG) 16. The camera signal of each frame is outputted from the image sensor 12 every 1/30 seconds. The outputted camera signal is converted into a digital signal by an A/D converter 20 via a well-known noise removal and a level adjustment in a CDS/AGC circuit 18.

A signal processing circuit 22 subjects camera data outputted from the A/D converter 20 to well-known signal processings such as color separation, an RGB conversion, a white balance adjustment, a YUV conversion, and so on so as to produce image data formed of a luminance component (Y data) and chrominance components (U data, V data). Produced image data is applied to a memory control circuit 24, and written into an image data storing area 26a of the SDRAM 26 by the memory control circuit 24.

A video encoder 28 reads out the image data stored in the image data storing area 26a through the memory control circuit 24, and encodes the read image data. The encoded image signal is supplied to a monitor 30, and an image that corresponds to the image signal is displayed on a screen.

A bank control circuit 32 fetches the vertical synchronization signal from the SG 16, and outputs a writing-use bank control signal and a reading-use bank control signal having a level can be changed in response to the vertical synchronization signal. Banks A and B are formed in the image data storing area 26a, the memory control circuit 24 writes the image data outputted from the signal processing circuit 22 into a bank that corresponds to a level of the writing-use bank control signal, and reads out the image data to be applied to the video encoder 28 from a bank that corresponds to a level of the reading-use bank control signal.

Upon receipt of a compression instruction from the CPU 40, a JPEG CODEC 34 causes the memory control circuit 24 to read out one frame of image data stored in the image data storing area 26a, and subjects the read image data to a compression process according to a JPEG format. JPEG data produced by the compression process is applied to the memory control circuit 24 from the JPEG CODEC 34, and stored into a JPEG data storing area 26b by the memory control circuit 24.

On the other hand, upon receipt of an expansion instruction from the CPU 40, the JPEG CODEC 34 causes the memory control circuit 24 to read out one frame of the JPEG data stored in the JPEG data storing area 26b or a refuge area 26c, and subject the read JPEG data to an expansion process according to the JPEG format. Upon obtaining the expanded image data, the JPEG CODEC 34 stores the expanded image data into the image data storing area 26a through the memory control circuit 24.

Recording/reproducing processes of the JPEG data are performed by the CPU 40 and the disk drive 36. At the time of recording, the CPU 40 reads out the JPEG data stored in the JPEG data storing area 26b through the memory control circuit 24, and applies the read JPEG data to the disk drive 36 together with a recording instruction. The JPEG data is recorded into a magnetooptical disk 38 according to an FAT (File Allocation Table) system by the disk drive 36. At the time of reproducing, the CPU 40 applies a reproducing instruction to the disk drive 36, and writes the JPEG data read out from the magnetooptical disk 38 by the disk drive 36 into the JPEG data storing area 26b through the memory control circuit 24. It is noted that the magnetooptical disk 38 is a non-volatile detachable recording medium.

A shutter button 46 and an operation panel 48 are wire-connected to a system controller 42, and a remote control apparatus 44 is wireless-connected to the system controller 42. When the shutter button 46, the operation panel 48 or the remote control apparatus 44 are operated, the system controller 42 applies to the CPU 40 a state signal corresponding to the operation.

A photographing/reproducing change key SW, an animation key AN, a set key ST, a cancel key CL, function keys F1, and F2 are provided on the operation panel 48. On the remote control apparatus, in addition to a shutter button 44a, provided are a photographing/reproducing change key SW′, an animation key AN′, a set key ST′, a cancel key CL′, function keys F1′, and F2′.

The photographing/reproducing change key SW or SW′ is a key for changing an operation mode between the photographing mode and the reproducing mode. The animation key AN or AN′ is a key that becomes effective in the photographing mode and for selecting the animation mode. The set key ST or ST′ is a key that becomes effective in the animation mode and for changing a display mode among “0”- “2”. The function key F1 or F1′ is a key for changing the display mode 2 to a display mode 2-A, and the function key F2 or F2′ is a key for changing the display mode 2 to a display mode 2-B. The cancel key CL or CL′ is a key for restoring from the animation photographing mode to a normal photographing mode.

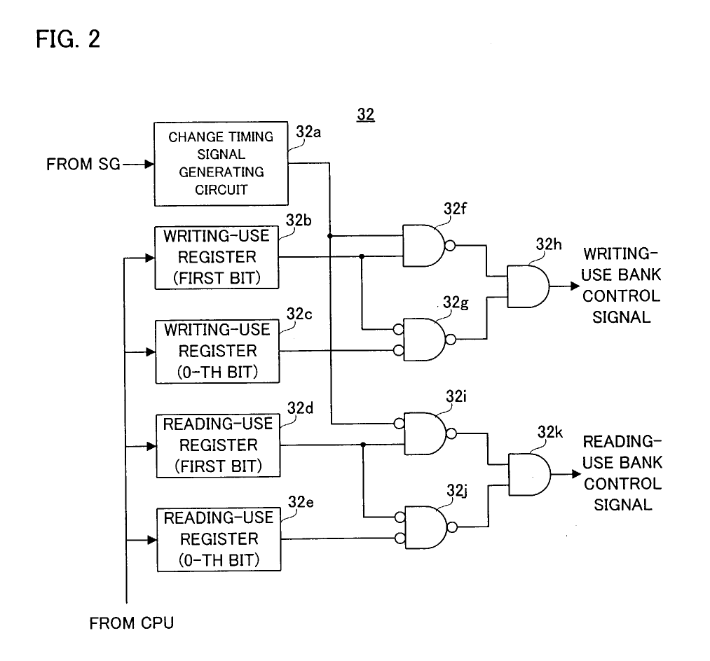

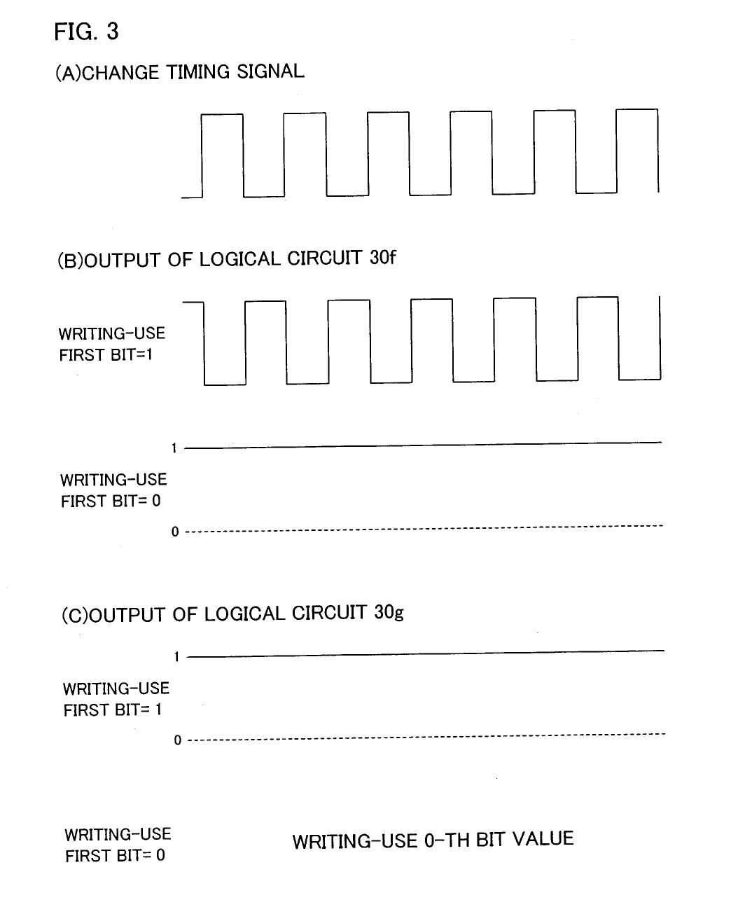

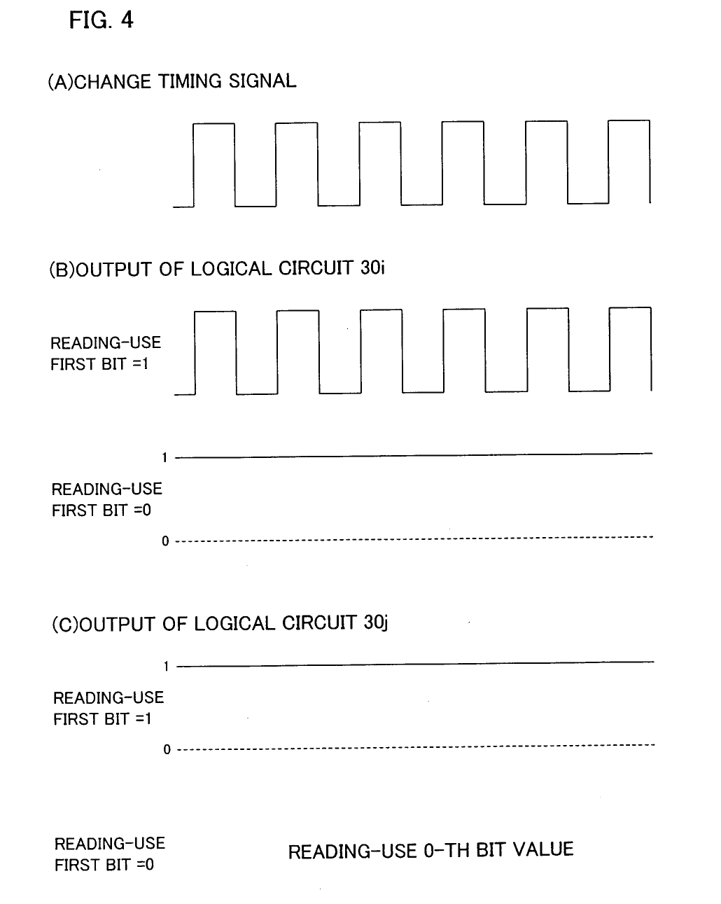

More specifically, the bank control circuit 32 is constituted as shown in FIG. 2. A change timing signal generating circuit 32a generates a change timing signal having a level to be changed every 1/30 seconds in response to the vertical synchronization signal outputted from the SG 16. The change timing signal draws a waveform as shown in FIG. 3 (A) or FIG. 4 (A). Numerical values corresponding to the display mode are set to the writing-use registers 32b, 32c and the reading-use registers 32d, 32e by the CPU 38. The writing-use register 32b holds a writing-use first bit value, and the writing-use register 32c holds a writing-use 0-th bit value. In addition, the reading-use register 32d holds a reading-use first bit value, and the reading-use register 32e holds a reading-use 0-th bit value.

The change timing signal is applied to one input terminal of the logical circuits 32f and 32i . The writing-use first bit value is applied to the other input terminal of the logical circuit 32f and one input terminal of the logical circuit 32g, and the writing-use 0-th bit value is applied to the other input terminal of the logical circuit 32g. The reading-use first bit value is applied to the other input terminal of the logical circuit 32i and one input terminal of the logical circuit 32j , the reading-use 0-th bit value is applied to the other input terminal of the logical circuit 32j.

Therefore, as understood from FIG. 3 (B), if the writing-use first bit value is “1”, a pulse signal in opposite phase to the change timing signal shown in FIG. 3 (A) is outputted from the logical circuit 32f, and if the reading-use first bit value is “0”, a high level signal is outputted from the logical circuit 32f. Furthermore, as shown in FIG. 3 (C), if the writing-use first bit value is “1”, the high level signal is outputted from the logical circuit 32g, and if the writing-use first bit value is “0”, a signal having a level corresponding to the writing-use 0-th bit value is outputted from the logical circuit 32g.

Moreover, as understood from the FIG. 4 (B), if the reading-use first bit value is “1”, the pulse signal in the same phase as the change timing signal shown in FIG. 4 (A) is outputted from the logical circuit 32i, and if the reading-use first bit value is “0”, the high level signal is outputted from the logical circuit 32i . In addition, as shown in FIG. 4 (C), if the reading-use first bit value is “1”, the high level signal is outputted from the logical circuit 32j, and if the reading-use first bit value is “0”, the signal having a level corresponding to the reading-use 0-th bit value is outputted from the logical circuit 32j.

A logical circuit 32h generates a writing-use bank control signal by subjecting an AND operation to the output of the logical circuits 32f and 32g. Furthermore, a logical circuit 32k generates a reading-use bank control signal by subjecting an AND operation to the output of the logical circuits 32i and 32j.

If the display mode 0 or 1 is selected, numerical values shown in Table 1 are set to the writing-use registers 32b, 32c, and the reading-use registers 32d, 32e by the CPU 40. Furthermore, if the display mode 2 is selected, numerical values shown in Table 2 are set to the writing-use registers 32b, 32c, and the reading-use registers 32d, 32e by the CPU 40. Still furthermore, if the display mode 2-A is selected, numerical values shown in Table 3 are set to the writing-use registers 32b, 32c, and the reading-use registers 32d, 32e by the CPU 40, and if the display mode 2-B is selected, numerical values shown in Table 4 are set to the writing-use registers 32b, 32c, and the reading-use registers 32d, 32e by the CPU 40.

TABLE 1

| | First bit | 0-th bit |
|---|---|---|
| Writing-use register | 1 | — |
| Reading-use register | 1 | — |

TABLE 2

| | First bit | 0-th bit |
|---|---|---|
| Writing-use register | 0 | 0 |
| Reading-use register | 1 | — |

TABLE 3

| | First bit | 0-th bit |
|---|---|---|
| Writing-use register | 0 | 0 |
| Reading-use register | 0 | 0 |

TABLE 4

| | First bit | 0-th bit |
|---|---|---|
| Writing-use register | 0 | 0 |
| Reading-use register | 0 | 1 |

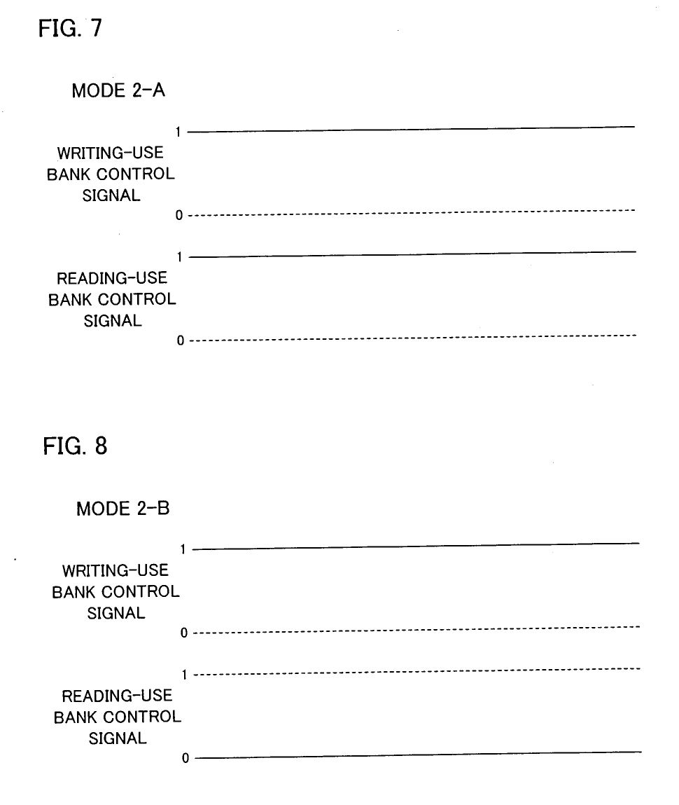

Therefore, the writing-use bank control signal and the reading-use bank control signal draw a waveform shown in the display mode 0 or 1, draw a waveform shown in FIG. 6 in the display mode 2, draw a waveform shown in FIG. 7 in the display mode 2-A, and draw a waveform shown in FIG. 8 in the display mode 2-B.

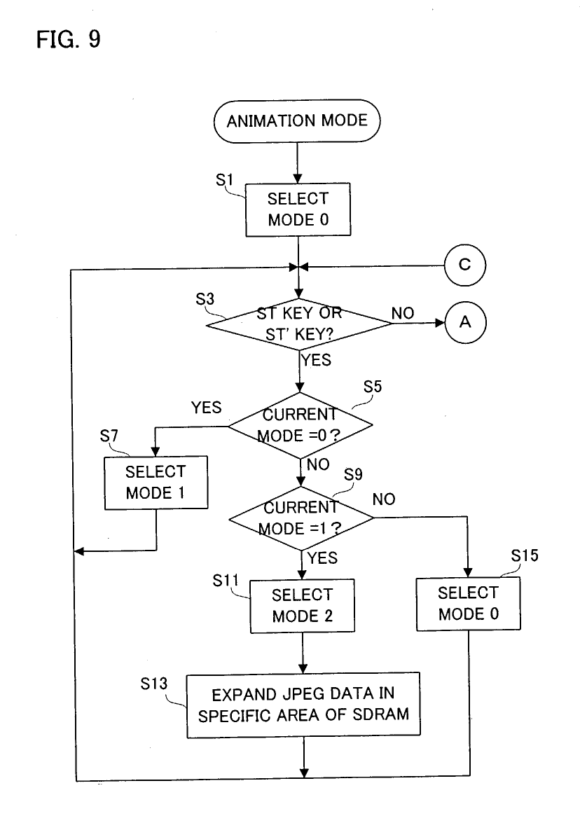

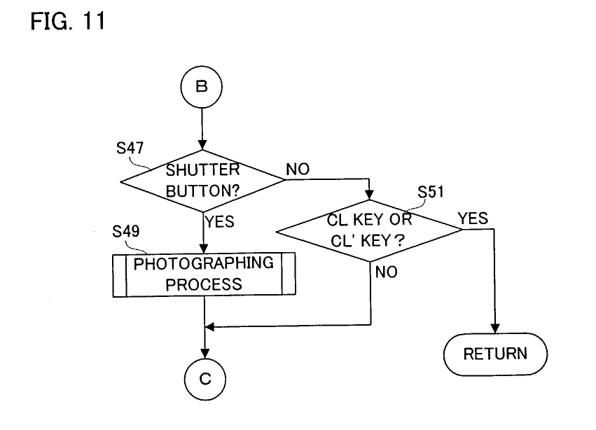

When the photographing mode is selected by the photographing/reproducing change switch SW or SW′, and the animation key AN or AN′ is operated, the CPU 40 carries out flowcharts shown in FIGS. 9-12. It is noted that a program corresponding to the flowchart is stored in a ROM 50.

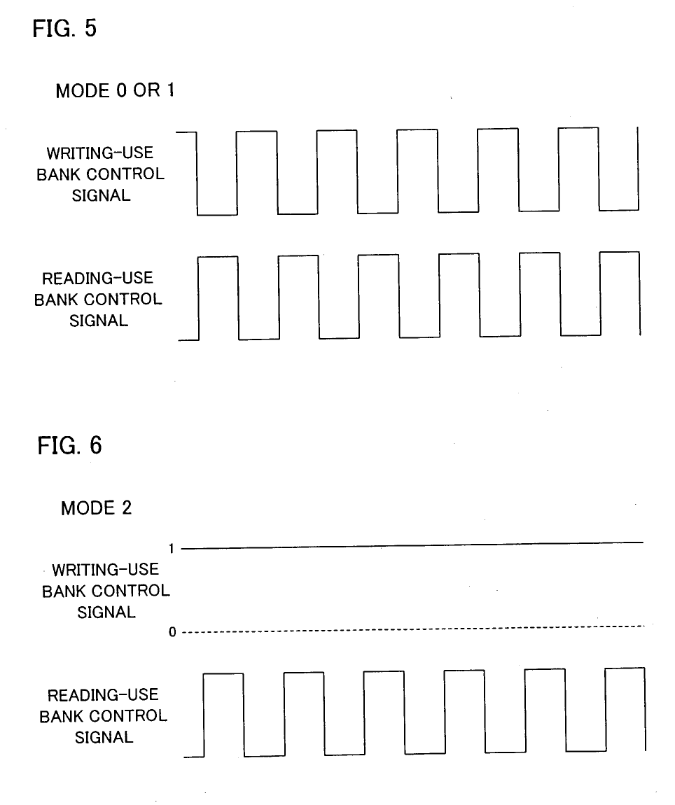

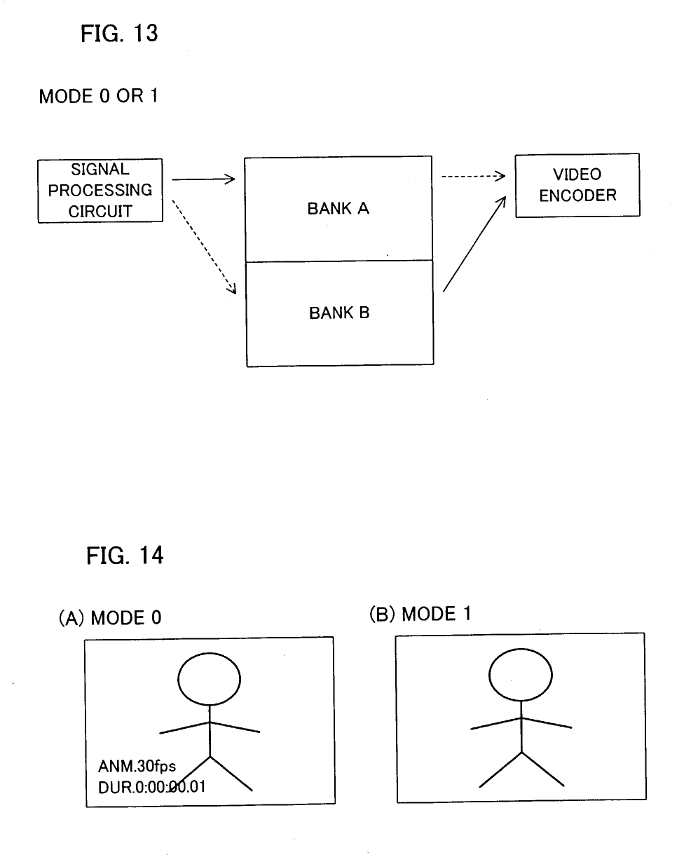

In a step S1, the numerical values shown in Table 1 are set to the bank control circuit 32 so as to select the display mode 0. This causes the writing-use bank control signal and the reading-use bank control signal shown in FIG. 5 to be outputted from the bank control circuit 32, and writing/reading operations of the image data are carried out according to FIG. 13. That is, if a writing destination of the image data outputted from the signal processing circuit 22 is the bank A, a reading destination of the image data to be applied to the video encoder 28 becomes the bank B. In contrary, if the writing destination of the image data outputted from the signal processing circuit 22 is the bank B, a reading destination of the image data to be applied to the video encoder 28 is the bank A.

In addition, in the display mode 0, a character generator not shown is turned on. The character generator outputs character data showing character information, and the character data is multiplexed onto the image data in the video encoder 28. As a result, a real time moving image of the object and mode information (ANM. 30 fps DUR. 0:00:00.01) are displayed on the monitor 30 as shown in FIG. 14 (A).

It is determined whether or not the set key ST or ST′ is operated in a step S3, and if YES is determined, a current display mode is determined in steps S5 and S9. If the current display mode is “0”, the process proceeds from the step S5 to a step S7 so as to turn off the character generator for selecting the display mode 1. A screen display changes from FIG. 14 (A) to FIG. 14 (B).

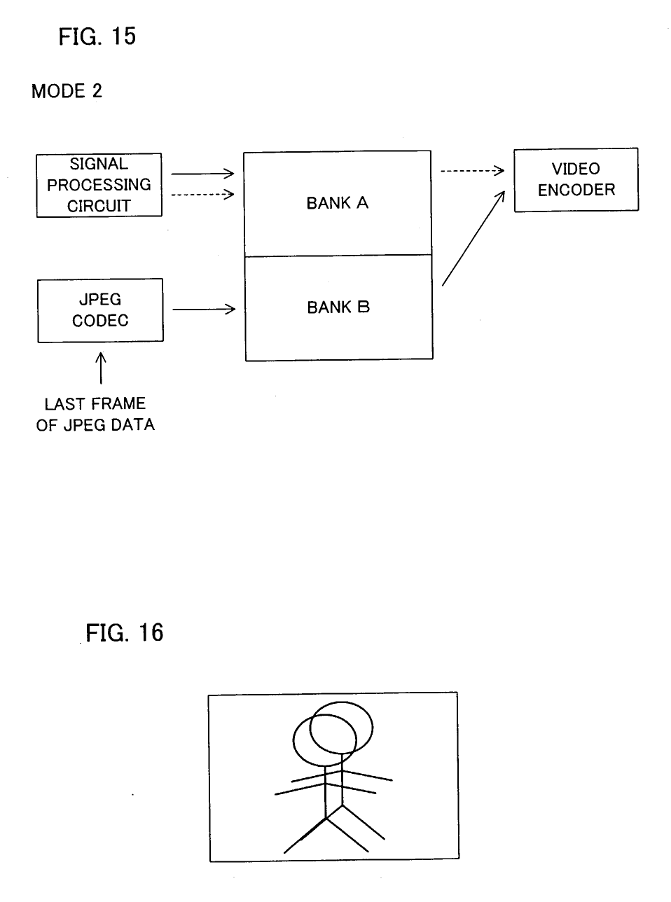

If the current display mode is “1”, the process proceeds from the step S9 to a step S11 so as to set the numerical values shown in Table 2 to the bank control circuit 32 for selecting the display mode 2. This causes the writing-use bank control signal and the reading-use bank control signal shown in FIG. 6 to be outputted from the bank control circuit 32, and the writing/reading operations of the image data are carried out according to FIG. 15. In a step S13, an expansion process of the JPEG data stored in the refuge area 26c of the SDRAM 26a is instructed to the JPEG CODEC 34. The JPEG CODEC 34 reads out the JPEG data from the refuge area 26c through the memory control circuit 24 so as to expand the JPEG data. The expanded image data is written into the bank B of the image data storing area 26a by the memory control circuit 24.

Although described later, the JPEG data stored in the refuge area 26c is data of the object recorded in response to a latest shutter operation. The image data obtained as a result of expanding such the JPEG data is stored in the bank B, and the image data outputted in a real time fashion from the signal processing circuit 22 is stored in the bank A. Then, the reading destination is switched between the banks A and B every 1/30 seconds. As a result, the moving image on the basis of still image data outputted from the signal processing circuit 22 and the recorded latest still image data is displayed on the monitor 30 according to FIG. 16.

If the current display mode is “2”, the process proceeds from the step S9 to a step S15 so as to set the numerical values shown in Table 1 to the bank control circuit 32 and turn on the character generator so as to select the display mode 0. The display of the monitor 30 returns to FIG. 14 (A).

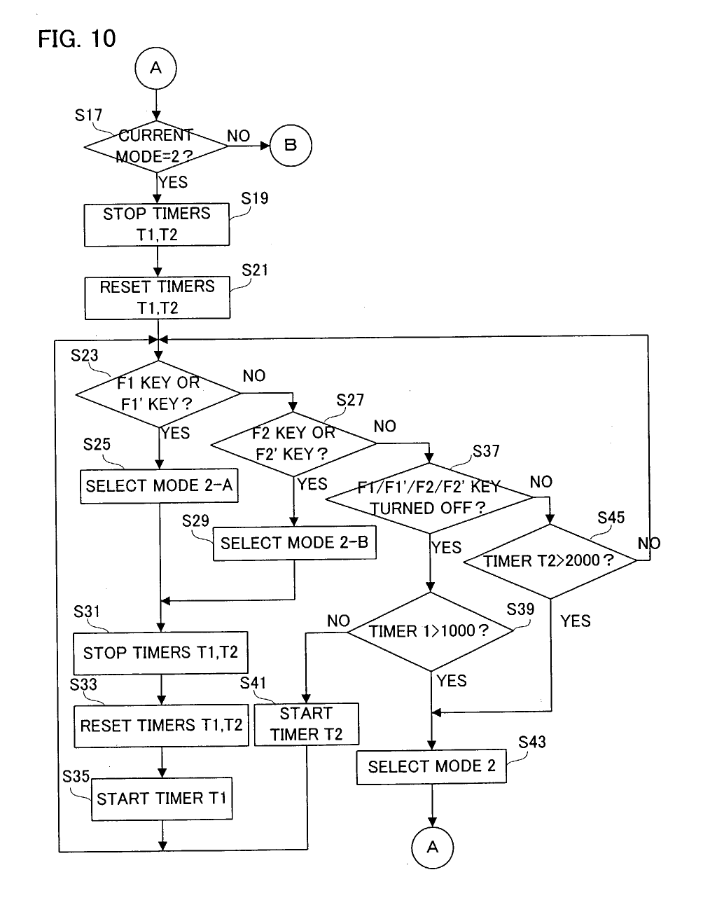

If NO is determined in the step S3, the current display mode is determined in a step S17 shown in FIG. 10, and if the display mode is “2”, processes of steps S19-S45 are carried out. Firstly, timers T1, T21 are stopped in the step S19, and numerical values of the timers T1 and T2 are reset in the steps of S21. In the steps of S23, S27, and S37, it is determined whether or not the function key F1, F1′, F2 or F2′ is operated.

In a case of continuously depressing the function key F1, F1′, F2 or F2′ for one second, for example, the system controller 42 outputs once the state signal showing an on state at a time of starting depressing, and outputs once the state signal showing an off state at a time of canceling depressing. In a time period of one second during which a depressing state continues, neither of the state signals is outputted. It is determined whether or not the depressing of the function key F1 or F1′ is started in the step S23, it is determined whether or not the depressing of the function key F2 or F2′ is started in the step S27, and it is determined whether or not the depressing of the function key F1, F1′, F2 or F2′ is cancelled in the step S37 .

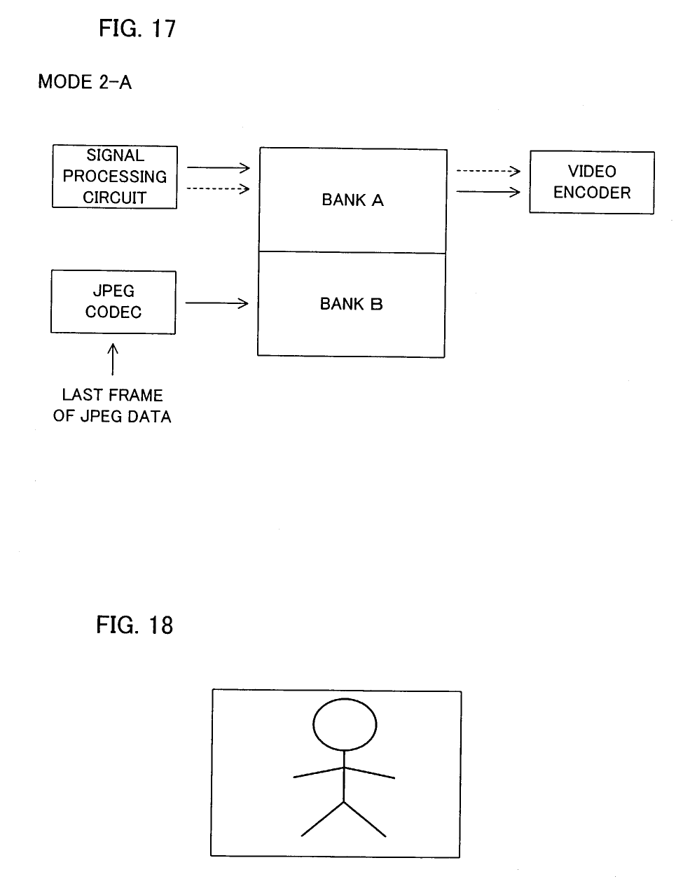

If the state signal showing the on state with respect to any one of the function keys F1 and F1′ is outputted, the process proceeds from the step S23 to the step S25 so as to set the numerical values shown in Table 3 to the bank control circuit 32 for selecting the display mode 2-A. This causes the writing-use bank control signal and the reading-use bank control signal shown in FIG. 7 to be outputted from the bank control circuit 32, and the writing/reading operations of the image data are carried out according to FIG. 17. That is, the bank A is always selected as the reading destination of the image data to be applied to the video encoder 28, and the real time moving image of the object is displayed on the monitor 30 according to FIG. 18.

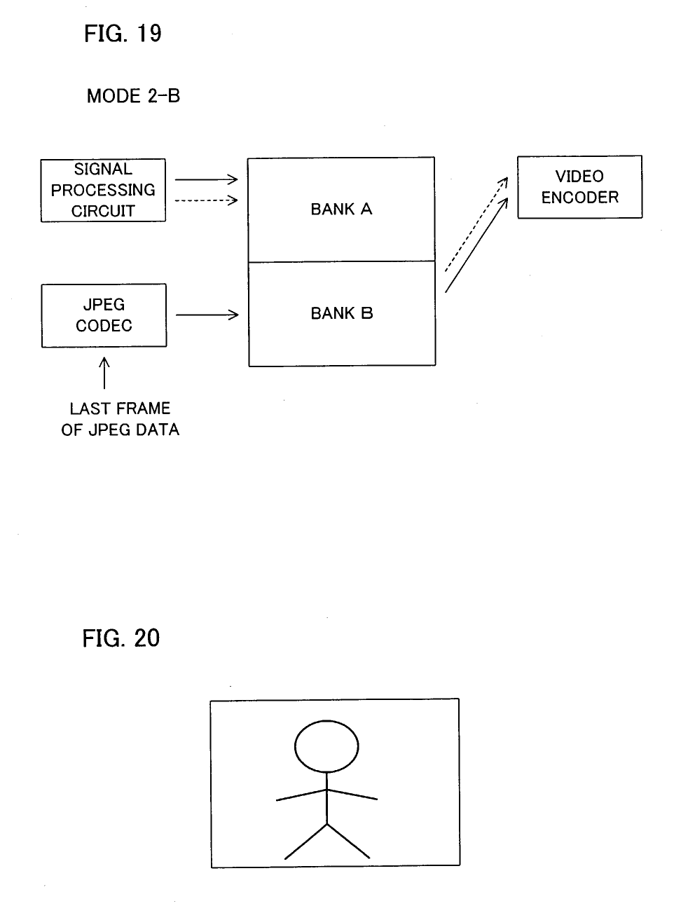

If the state signal showing the on state with respect to any one of the function keys F2 and F2′ is outputted, the process proceeds from the step S27 to the step S29 so as to set the numerical values shown in Table 4 to the bank control circuit 32 for selecting the display mode 2-B. This causes the writing-use bank control signal and the reading-use bank control signal shown in FIG. 8 to be outputted from the bank control circuit 32, and the writing/reading operations of the image data are carried out according to FIG. 19. That is, the bank B is always selected as the reading destination of the image data to be applied to the video encoder 28, and the recorded latest still image is displayed on the monitor 30 according to FIG. 20.

Upon completion of the step S25 or S29, the timers T1, T2 are stopped in the step S31, and the timers T1, T2 are reset in the step S33, and the timer T1 is started in the step S35. That is, when a depressing of the function key F1 or F2 is started, only the timer T1 starts to measure a time period. Upon completion of the process in the step S35, the process returns to the step S23.

If the state signal showing the off state with respect to any one of the function key F1, F1′, F2 or F2′ is outputted, the process proceeds from the step S37 to the step S39, assuming that the depressing state is cancelled. In the step S39, the measuring time period by the timer T1 is compared with 1.000 milliseconds. If the measuring time period exceeds 1.000 milliseconds, the process proceeds to the step S43 so as to set the numerical values shown in Table 2 to the bank control circuit 32 for selecting the display mode 2. That is, if the depressing time period of the function key F1, F1′, F2 or F2′ is equal to or longer than 1 second, the display mode 2 is selected concurrently with canceling the depressing. Upon completion of the process in the step S43, the process returns to the step S17.

If the measuring time period by the time T1 is equal to or shorter than 1.000 milliseconds, the timer T2 is started in the step S41, and returns to the step S23 thereafter. The measuring time period by the timer T2 is determined in the step S45, and if the measuring time period exceeds 2.000 milliseconds, the display mode 2 is selected in the step S43. That is, if the depressing time period of the function key F1, F1′, F2 or F2′ is equal to or shorter than 1 second, the measuring time period by the timer T2 is started concurrently with canceling the depressing, and at a point of time that 2 seconds are elapsed since canceling the depressing, the display mode 2 is selected.

Thus, a difference in time period required for returning to the display mode 2 is produced in correspondence with the operating manners of the function keys F1, F1′, F2 and F2′, allowing to improve operationality.

If the current display mode is “0”, or “1”, NO is determined in the step S17, in addition to determining whether or not the shutter button 44a or 46 in the step S47, it is determined whether or not the cancel key CL or CL′ is operated in a step S51. When the shutter button 44a or 46 is operated, a photographing process is carried out in a step S49, and the process returns to the step S3 upon completion of the process. In addition, when the cancel key CL or CL′ is operated, the animation mode is ended.

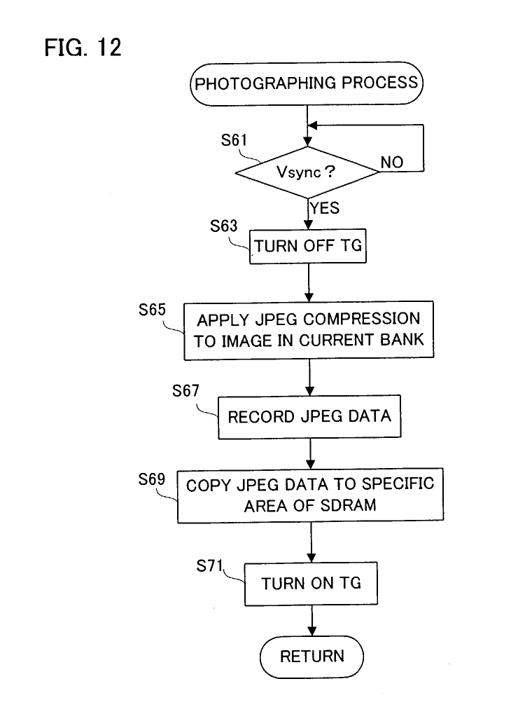

The photographing process in the step S49 is carried out according to a subroutine shown in FIG. 12. Firstly, it is determined whether or not the vertical synchronization signal is produced in a step S61, and if YES is determined, the TG 14 is turned off in a step S63. As a result of the TG 14 being turned off, the output of the image data from the signal processing circuit 22 is interrupted. In a step S65, the JPEG CODEC 34 is instructed to compress the image data stored in a current bank.

The JPEG CODEC 34 reads out the image data from the current bank through the memory control circuit 24, and subjects the image data to a JPEG compression. The JPEG data produced as a result thereof is written into the JPEG data storing area 26b by the memory control circuit 24. It is noted that the current bank is a bank in which the latest image data is stored out of the bank A and B.

The JPEG data stored in the JPEG data storing area 26b is read out through the memory control circuit 24 in a step S67, and the read JPEG data is applied to the disk drive 36, together with a recording instruction. The JPEG data is recorded into the magnetooptical disk 38 by the disk drive 36.

In a step S69, the JPEG data stored in the JPEG data storing area 26b is copied to the refuge area 26c. More specifically, the JPEG data stored in the JPEG data storing area 26b is once read out through the memory control circuit 24, and the read JPEG data is written into the refuge area 26c through the memory control circuit 24. This allows to obtain in the refuge area 26c the same JPEG data as the latest JPEG data recorded in the magnetooptical disk 38. Upon completion of the process in the step S69, the TG 14 is turned on in a step S71, and returns to a routine on a higher hierarchy later.

According to this embodiment, the signal processing circuit 22 sequentially outputs a plurality of frames of the still image data which correspond to the object image. If the shutter button 44a or 46 is operated in the animation mode, one frame of the still image data is recorded into the magnetooptical disk 38 in a compressed state. If the display mode 2 is selected in the animation mode, the recorded latest still image data and the still image data outputted from the signal processing circuit 22 are alternately selected, and the moving image on the basis of the selected still image data is displayed on the monitor 30. Therefore, it is possible to easily confirm a change amount of the object by taking advantage of afterimage effect.

Furthermore, a key inputting by the remote control apparatus 44 is made possible so that a camera position is not moved at a time of changing the display mode, operating the shutter, and so on. This allows to improve operating efficiency.

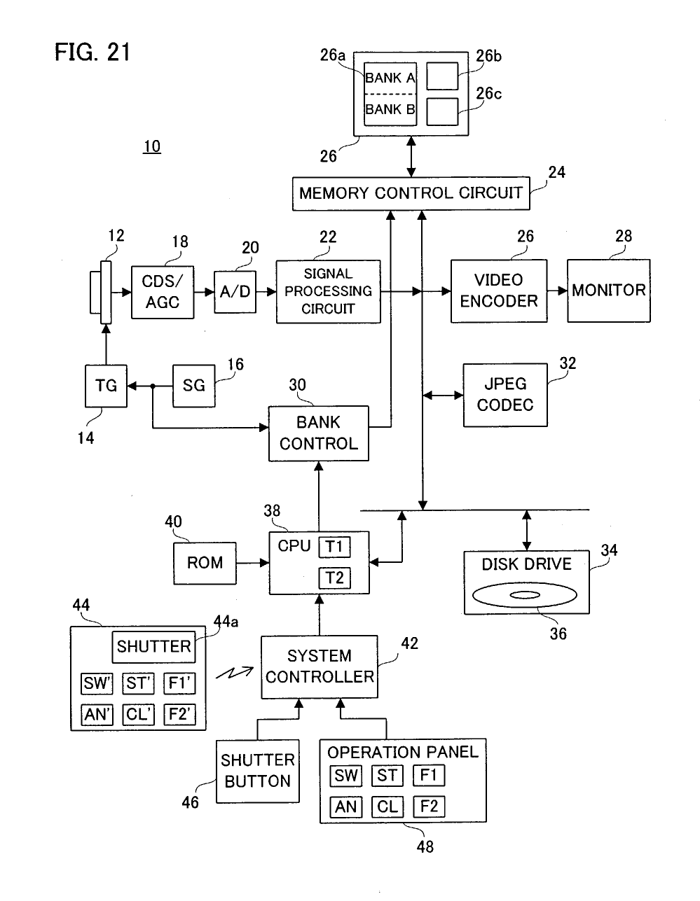

Referring to FIG. 21, the digital camera 10 in another embodiment is the same as in the FIG. 1 embodiment except for following points to be described so that duplicated descriptions with regard to the similar portions are omitted.

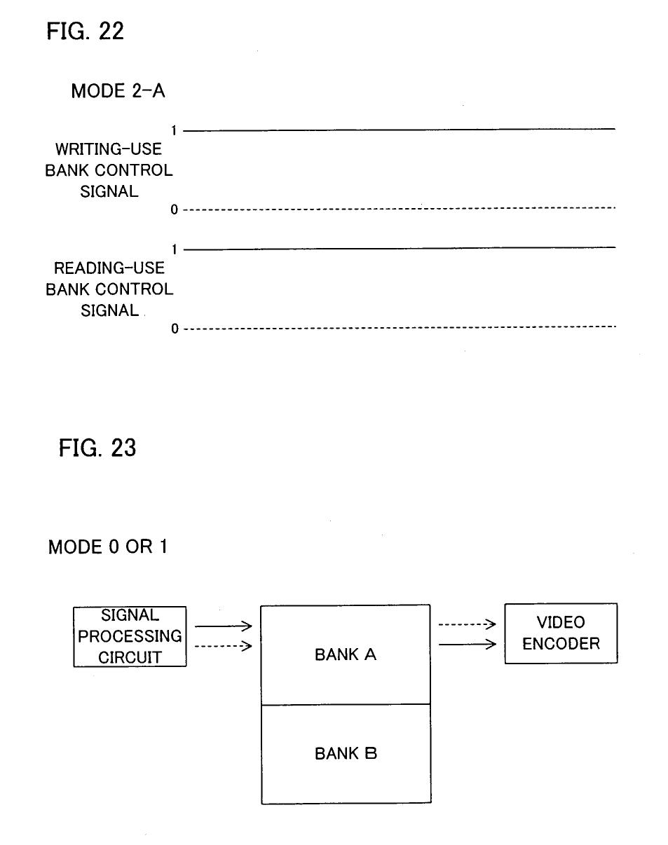

In the mode 0 or 1, numerical values shown in Table 5 are set to the bank control circuit 32, and the writing-use bank control signal and the reading-use bank control signal shown in FIG. 22 are outputted from the bank control circuit 32. The writing/reading operations of the image data are carried out according to FIG. 23. That is, the bank A is always selected as the writing destination of the image data outputted from the signal processing circuit 22 and the reading destination of the image data to be applied to the video encoder 28.

TABLE 5

| | First bit | 0-th bit |
|---|---|---|
| Writing-use register | 0 | 0 |
| Reading-use register | 0 | 0 |

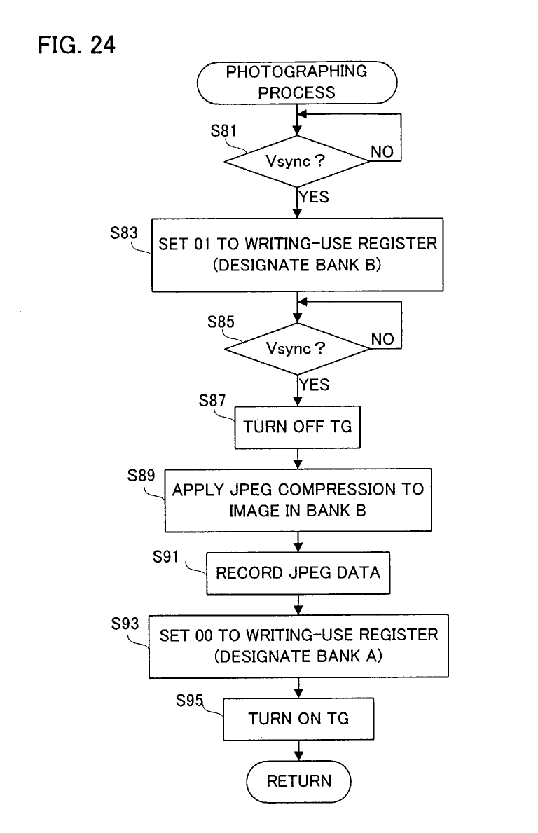

The photographing process carried out when the shutter button 44a or 46 is operated in the animation mode complies with a subroutine shown in FIG. 24. It is determined whether or not the vertical synchronization signal is produced in a step S81, and if YES is determined, “0” and “1” are set to the reading-use registers 32b and 32c in a step S83. This allows the image data outputted from the signal processing circuit 22 after YES is determined in the step S81 to be written into the bank B. It is determined once again whether or not the vertical synchronization signal is produced in a step S85, and if YES is determined, the TG 14 is turned off in a step S87. As a result, the image data stored in the bank B is not to be overwritten by the image data that follow.

In a step S89, the JPEG CODEC 34 is instructed to compress the image data stored in the bank B. The JPEG CODEC 34 reads out the image data from the bank B through the memory control circuit 24, and subjects the image data to a JPEG compression. The JPEG data generated as a result thereof is written into the JPEG data storing area 26b by the memory control circuit 24.

The JPEG data stored in the JPEG data storing area 26b is read out through the memory control circuit 24 in a step S91, and the read JPEG data is applied to the disk drive 36, together with a recording instruction. The JPEG data is recorded into the magnetooptical disk 38 by the disk drive 36.

In a step S93, “0” and “1” are set to the writing-use registers 32b and 32c for returning the writing destination of the image data outputted from the signal processing circuit 22 to the bank A. Upon completion of the process in the step S93, the TG 14 is turned on in a step S95, and the process returns to a routine on a higher hierarchy later.

According to this embodiment, the writing destination of the image data in the display mode 0 or 1 is fixed in the bank A, and if the shutter button 44a or 46 is operated, the image data as of that time is retained in the bank B. Therefore, it is not needed to expand the JPEG data at every time that the display mode 2 is selected, thus enabling to improve a responsive characteristic in response to switching the mode.

It is noted that in this embodiment, the still image forming the real time moving image and the recorded latest still image are alternately switched by each one frame when the display mode 2 is selected. However, a switching period may be arbitrarily determined on condition that each of the still images be surely selected. The latest still image recorded may be N-frame displayed (N: integer other than M) at every time that the still images forming the real time moving image to be M-frame displayed (M: integer) and the latest still image recorded may be L-frame displayed (L: integer other than 2) at every time that the still image forming the real time moving image to be L-frame displayed. The switching period may be changed randomly.

Furthermore, the remote control apparatus in this embodiment is wireless-connected to the system controller. However, this may be connected by a cable.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital camera, comprising:
a photographer for sequentially outputting a plurality of screens of still image signals that correspond to an object image;
a recorder for recording one screen of the still image signal at every time that a recording instruction is issued; and
a displayer for displaying a moving image formed of one screen of the still image signal that corresponds to a latest recording instruction and the still image signals outputted from said photographer when a specific display instruction is issued.

2. A digital camera according to claim 1, further comprising a remote controller that is prepared separately from a main body, and issues at least one of said recording instruction and said specific display instruction in response to a key operation.

3. A digital camera according to claim 1, further comprising:
a first memory for storing one screen of the still image signal that corresponds to said latest recording instruction;
a second memory for storing the still image signals sequentially outputted from said photographer; and
a changer for alternately changing a reading destination of the still image signals forming said moving image between said first memory and said second memory.

4. A digital camera according to claim 3, further comprising a suspender for suspending a change operation of said changer in response to a change suspending instruction after said specific display instruction.

5. A digital camera according to claim 4, further comprising an input key for inputting said change suspending instruction, wherein said suspender determines a suspending time period of said change operation on the basis of an operating manner of said input key.

6. A signal processing method of a digital camera provided with a photographer for sequentially outputting a plurality of screens of still image signals corresponding to an object image, and a recorder for recording one screen of the still image signal at every time that a recording instruction is issued, comprising steps of:
(a) storing into a first memory one screen of the still image signal corresponding to a latest recording instruction;
(b) storing into a second memory the still image signals sequentially outputted from said photographer;
(c) alternately changing a reading destination of the still image signals between said first memory and said second memory; and
(d) displaying a moving image on the basis of the still image signals read out from said first memory and said second memory.
